(19) United States
(12) Patent Application Publication
(10) Pub. No.: US 2025/0317713 A1
(43) Pub. Date: Oct. 9, 2025

(54) METHOD FOR DISCOVERING A RADIO COMMUNICATION NETWORK AND FOR FILTERING AN AUDIO SIGNAL ENABLING A GROUP COMMUNICATION

(71) Applicant: SAFEHEAR, LYON (FR)

(72) Inventors: Antoine KUHNAST, LYON (FR); Andrew SONZOGNI, LYON (FR)

(21) Appl. No.: 18/865,986

(22) PCT Filed: May 26, 2023
(86) PCT No.: PCT/EP2023/064284

§ 371 Date: Nov. 14, 2024

(30) Foreign Application Priority Data
May 27, 2022 (FR) FR2205095

(51) Int. Cl. H04W 4/08; G10L 19/00; G10L 25/21; G10L 25/78; G10L 25/84; H04B 17/318

(52) U.S. Cl. CPC H04W 4/08; G10L 19/00; G10L 25/21; G10L 25/84; H04B 17/318; G10L 2025/783

(57) ABSTRACT

A method for discovering a radio communication network and for filtering an audio signal allowing a group communication between a plurality of electronic terminals collocated in a radio zone, the method including transmission of a first radio signal by a first electronic terminal; calculation of a received signal strength value and comparison of the calculated received signal strength value with a first threshold; reception of the first radio signal by a plurality of electronic terminals.

### FIELD OF INVENTION

The field of the invention relates to the field of radio communication methods. More particularly, the field of the invention relates to the field of radio communication methods and audio signal filtering. In particular, the field of the invention relates to the field of radio communication methods and audio signal filtering in a group communication context.

### PRIOR ART

Today, safety and well-being at work are among the biggest challenges for industrial companies. To ensure the safety of their employees, employers are obliged to provide them with personal protective equipment, also known as PPE. These protect employees from the risks to which they are exposed on a daily basis. Such equipment may notably comprise helmets, goggles, safety shoes, and gloves. When employees are exposed to particularly noisy work environments, for example a construction site or a machine room, it is also important to ensure the hearing safety of employees. For this purpose, PPE may also comprise hearing protectors.

While these hearing protectors can be particularly effective in protecting employees from risks due to long-term exposure to high noise levels, another challenge is to enable employees to communicate effectively with each other in these noisy environments. Indeed, existing hearing protectors have the drawback of isolating employees from each other and do not allow group communication.

Systems exist in the prior art allowing group communication between several users. For example, portable communication devices are known to communicate with each other, for example via a radio channel. These are, for example, portable radio transmitter-receiver systems enabling a radiophonic connection over short distances. Such systems are generally referred to in the literature as “Walkie-Talkie”. However, a problem exists, since the surrounding noise, intrinsic to the environment in which the employee works, has a negative impact on the quality of communication.

However, such systems have the drawback of having poor filtering performance and require manual action by the user to speak. In addition, these systems do not make it possible to effectively manage changes in communication channels. They are therefore unsuitable for certain environments, for example a noisy production line in which it is wished to set up an efficient group communication between several users. Other environments may also be affected by such a problem, notably concert halls, the building and construction sector, sports environments, for example for cyclists or skiers, and more generally any environment in which the surrounding noise exerts a negative influence on the quality of communication between several users.

Methods allowing group communication between a set of collocated devices are known in the prior art. For example, patent FR3076154 describes a telecommunication method in a group consisting of a plurality of apparatuses, via a connection according to the IEEE 802.11 standards of a wireless local network. However, this patent describes the implementation of a Wi-Fi protocol requiring the configuration of a centralizing apparatus. One problem with this method is that group communication is only allowed through this centralizing apparatus, which receives the signals transmitted by one of the terminals to retransmit them to the other terminals. In other words, such a system cannot operate if the centralizing apparatus is not present in the communication network, which makes the implementation complex and unsuitable for certain use cases. Another problem with such a method is that it does not make it possible to limit poor quality signals, for example signals transmitted at the communication range limit. Another drawback is that the energy consumption of the system is high due to the electrical power consumption of the centralizing apparatus.

Another example is patent FR2988549 which describes a communication terminal that comprises a digital communication circuit using time multiplexing on a radio channel and implementing wireless communication in “conference” and “hands-free” mode on an autonomous network, between at least two carriers of counterpart devices. This patent describes a synchronization technique requiring the definition of clocks and master/slave terminals to implement the “conference” mode. One problem with this solution is that it also does not make it possible to limit poor quality signals during group communication.

One aim of the invention is to limit at least one of the aforementioned drawbacks.

### SUMMARY OF THE INVENTION

To this end, and according to a first aspect, the invention relates to a method for discovering a radio communication network and for filtering an audio signal, said method allowing a group communication between a plurality of electronic terminals collocated in a radio zone, each electronic terminal comprising at least one communication interface for transmitting and receiving radio signals, the method including:
Transmission of a first radio signal by a first electronic terminal including:
   Acquisition of the first audio signal by a microphone
   Detection of a characteristic data of a voice in the first audio signal by the implementation of a first signal processing function;
   Implementation of a first control law to implement the following steps when the characteristic data of a voice has been detected in the first audio signal;
      i. Filtering, encoding comprising a step of compression and modulation, by a signal processing chain, of said first received audio signal to obtain the first radio signal capable of being transmitted within a radio channel;
      ii. Transmission of the first radio signal by means of a radio transmitter and via a wireless connection;
Calculation of a received signal strength value and comparison of said calculated received signal strength value with a first threshold;
Reception of said first radio signal by a plurality of electronic terminals, comprising:
   Detection of the first radio signal by a radio communication interface of each terminal among the plurality of electronic terminals;
   Baseband demodulation comprising the first filtered audio signal of said first radio signal;
   Decompression and amplification, by a second signal processing chain, of said first filtered audio signal;
   Delivery of the first decompressed and amplified audio signal to an audio output of each terminal among the plurality of electronic terminals;

According to one embodiment, the method comprises a step of pairing between the first electronic terminal and the plurality of electronic terminals prior to the transmission step, said pairing step comprising:
Calculation, by each electronic terminal of the plurality of electronic terminals, of a second received signal strength value of a pairing signal transmitted by the first electronic terminal;
Comparison, with a second threshold, of said second calculated received signal strength value;
Implementation of a second control law comprising:
   generation of an authorization control to transmit the first radio signal when the second calculated received signal strength value is greater than or equal to the second threshold,
   generation of a control to block the transmission of the first radio signal when the second calculated received signal strength value is less than the second threshold.

One advantage is to reduce the overall power consumption of the system by conditioning the pairing of terminals to each other at a minimum level of received signal strength.

According to one embodiment, the encoding implemented by the first control law comprises the encoding of an identifier of the first terminal. This is, for example, a MAC address of the first terminal.

According to one embodiment, group communication between the electronic terminals is implemented according to the IPv6 Thread network protocol.

According to one embodiment, the pairing step comprises an addressing step comprising the assignment of an IP address to at least one terminal of the plurality of terminals by the first terminal.

According to one embodiment, the communication interface of each electronic terminal allows wireless communications broadcast to the other terminals, and allows the transmission and reception, by each electronic terminal, of datagrams in accordance with a user datagram protocol.

According to one embodiment, the filtering of the first local audio signal in the transmission step is performed by means of a low-pass filter whose cut-off frequency is between 300 Hz and 400 Hz.

One advantage is to enable the implementation of a method comprising or not the implementation of a routing table.

According to one embodiment, the communication interface of each electronic terminal allows wireless communications broadcast to the other terminals, and allows the transmission and reception, by each electronic terminal, of datagrams in accordance with a transmission control protocol.

One advantage is to allow a group communication in a “conference” mode between several users colocated in a same radio zone.

According to one embodiment, the filtering of the first local audio signal in the transmission step is performed by means of a bandpass filter whose bandwidth is between 300 Hz and 3.5 kHz.

According to one embodiment, the steps of demodulation and decompression of the first radio signal are implemented by the plurality of electronic terminals only when the first received radio signal strength value Sᵣ₁ is greater than a predetermined threshold.

According to one embodiment, the detection of the characteristic data of a voice in the first audio signal comprises:
the detection of a spectrogram characteristic of a voice or;
the detection of a characteristic strength of a voice or;
the detection of a characteristic spectral density of a voice or;
the detection of a characteristic spectral pattern of a voice or,
the calculation of a baseband signal-to-noise ratio.

One advantage is to enable the detection of the characteristic data of a voice in the first audio signal as a function of different parameters.

According to one embodiment, at least one electronic terminal among the plurality of electronic terminals is a leader terminal managing a routing table of the radio communication network.

One advantage is to allow the management of the radio communication of the electronic terminals as a function of the inputs and outputs of the communication bubble delimited by the radio zone G.

Another advantage is to allow the switchover of the leader function to another electronic terminal when the current leader terminal leaves the radio zone G.

According to one embodiment, the steps of demodulation, decompression and delivery are implemented only when the first received radio signal strength value is greater than a predetermined threshold.

According to another aspect, the invention relates to a communication system comprising a plurality of electronic terminals capable of communicating with each other when said plurality of electronic terminals is colocated in a same radio zone, each electronic terminal comprising:
A microphone to acquire a first audio signal;
A radio transmitter to:
   Transmit a first radio signal within a radio channel;
A radio receiver to receive a radio signal comprising a data frame encoding an audio signal;
A first control unit to execute a first signal processing chain configured to implement:
   A step of processing the first audio signal acquired by the microphone comprising:
      i. detection of a characteristic data of a voice in the first local audio signal by means of a signal processing function;
      ii implementation of a first control law when the characteristic data of a voice has been detected in the first local audio signal, comprising the filtering of the first audio signal to obtain a first filtered audio signal;
A second control unit to implement:
   Before the transmission of the first radio signal:
      i. reception of the first filtered audio signal;
      ii. encoding comprising the compression and modulation of the first filtered audio signal to obtain the first radio signal capable of being transmitted within a radio channel;
   On reception of a radio signal:
      i. calculation of a received radio signal strength value and comparison of said calculated received radio signal strength value with a first threshold;
      ii. Baseband demodulation of the received radio signal to obtain an audio signal;
      iii. Decompression of said audio signal,
      iv. Delivery of the decompressed audio signal to the first control unit which amplifies said decompressed audio signal and delivers said decompressed and amplified audio signal to an audio output of the terminal.

According to one embodiment, the second control unit is configured to implement a control law comprising:
a generation of a radio signal reception authorization control when the calculated received signal strength value is greater than or equal to the first threshold,
generation of a control to block reception of the radio signal when the calculated received signal strength value is less than the first threshold.

According to one aspect, the invention relates to a computer program product comprising instructions which, when the program is executed by a computer, lead the latter to implement the following steps
Detection of a characteristic data of a voice in a first audio signal acquired by a microphone of an electronic terminal;
Implementation of a first control law, when the characteristic data of a voice is detected in the first audio signal, comprising:
   Filtering of the first audio signal;
   Encoding comprising the compression of the first audio signal by means of an audio codec;
   Modulation of the first audio signal to obtain a first radio signal capable of being transmitted within a radio channel by a radio transmitter.

According to one aspect, the invention relates to a method for discovering a radio communication network and for filtering an audio signal, said method allowing a group communication between a plurality of electronic terminals colocated in a radio zone, each electronic terminal comprising at least one communication interface for transmitting and receiving radio signals, the method including:
Transmission of a first radio signal by a first electronic terminal including:
   Acquisition of the first audio signal by a microphone
   Detection of a characteristic data of a voice in the first audio signal by the implementation of a first signal processing function;
   Implementation of a first control law to implement the following steps when the characteristic data of a voice has been detected in the first audio signal;
      Filtering, encoding comprising a step of compression and modulation, by a signal processing chain, of said first acquired audio signal, to obtain the first radio signal capable of being transmitted within a radio channel;
      Transmission of the first radio signal by means of a radio transmitter and via a wireless connection;
Reception of said first radio signal by a plurality of electronic terminals, comprising:
   Detection of the first radio signal by a radio communication interface of each terminal among the plurality of electronic terminals;
   Calculation of a received signal strength value and comparison of said calculated received signal strength value with a first threshold;
   Implementation of the following steps when said received signal strength value is greater than said first threshold:
      Baseband demodulation comprising the first filtered audio signal of said first radio signal;
      Decompression and amplification, by a second signal processing chain, of said first filtered audio signal,
      Delivery of the first decompressed and amplified audio signal to an audio output of each terminal among the plurality of electronic terminals.

According to one embodiment, the received signal strength value comprises a communication quality indicator, and in which the calculation of said received signal strength value comprises the calculation of an exponential moving average of strength values of a plurality of first radio signals transmitted by the first terminal.

According to one embodiment, the signal processing function for detecting the characteristic data of a voice is implemented automatically in response to the acquisition of the first audio signal by the microphone.

According to one embodiment, the method comprises:
acquisition of a second surrounding noise audio signal by means of a microphone;
calculation of a first energy level of the first audio signal and a second energy level of the second audio signal by means of the first control unit;
automatic parameterization of a voice detection threshold as a function of the calculated energy level of the second audio signal;
comparison of the first energy level with said voice detection threshold,
   the first control law being implemented when the first energy level is greater than the voice detection threshold.

According to one embodiment, the method comprises:
acquisition of a plurality of second audio signals by means of a microphone for a first duration;
calculation of an average energy level of the second audio signals by means of the first control unit;
automatic parameterization of the voice detection threshold as a function of the average energy level calculated by means of the first control unit.

According to one embodiment, the average energy level of the second audio signals is automatically and periodically recalculated, the voice detection threshold being automatically recalculated each time said average energy level of the second signals is recalculated.

According to one embodiment, the detection of the characteristic data of a voice in the first audio signal comprises the comparison of the first energy level with the voice detection threshold, the characteristic data of a voice being detected when the first energy level is greater than the voice detection threshold.

According to one embodiment, the step of transmitting the first radio signal comprises a step of normalizing sound intensity parameters of the first audio signal as a function of a parameterizable threshold.

According to one embodiment, the step of receiving the first radio signal comprises a step of identifying the first electronic terminal by the receiving terminal, said identification comprising a comparison of a sequence of parameters of the first radio signal with predefined parameters to authorize or not the reception of the first radio signal.

According to one embodiment, the step of transmitting the first radio signal comprises a real-time comparison of a number of transmitters within a radio channel with a threshold value, the first control law being implemented only when said number of transmitters is less than said threshold value.

According to one embodiment, the reception of the first radio signal comprises the implementation of an algorithm to generate a non-received or degraded portion of said first radio signal from a received portion of said first radio signal.

According to one embodiment, the reception of the first radio signal comprises the implementation of an algorithm to generate a non-received or degraded portion of said first radio signal from a received portion of said first radio signal.

According to another aspect, the invention relates to a communication system comprising a plurality of electronic terminals capable of communicating with each other when said plurality of electronic terminals is colocated in a same radio zone, each electronic terminal comprising:
a microphone to acquire a first audio signal;
a radio transmitter to transmit a first radio signal within a radio channel;
a radio receiver to receive a radio signal comprising a data frame encoding an audio signal;
a first control unit to execute a first signal processing chain configured to implement:
   a step of processing the first audio signal acquired by the microphone comprising:
      detection of a characteristic data of a voice in the first local audio signal by means of a signal processing function;
      implementation of a first control law when the characteristic data of a voice has been detected in the first local audio signal, comprising the filtering of the first audio signal to obtain a first filtered audio signal;
a second control unit to implement:
   Before the transmission of the first radio signal:
      reception of the first filtered audio signal;
      encoding comprising the compression and modulation of the first filtered audio signal to obtain the first radio signal capable of being transmitted within a radio channel;
   On reception of a radio signal:
      calculation of a received radio signal strength value and comparison of said calculated received radio signal strength value with a first threshold and, when said received radio signal strength value is greater than the first threshold:
         baseband demodulation of the received radio signal to obtain an audio signal;
         decompression of said audio signal,
         delivery of the decompressed audio signal to the first control unit which amplifies said decompressed audio signal and delivers said decompressed and amplified audio signal to an audio output of the terminal.

In one embodiment, the second control unit is configured to implement a control law comprising:
generation of a radio signal reception authorization control when the calculated received signal strength value is greater than or equal to the first threshold,
generation of a control to block reception of the radio signal when the calculated received signal strength value is less than the first threshold.

### BRIEF DESCRIPTION OF THE FIGURES

Other features and advantages of the invention will become clearer upon reading the following detailed description, in reference to the appended figures, that illustrate:

FIG. 1: a schematic representation of the method of the invention implemented in the context of group communication between four electronic terminals co-located in a same radio zone.

FIG. 2: a schematic representation of the steps of the method of the invention, represented in accordance with the example of radio communication between two electronic terminals.

FIG. 3: a detailed schematic representation of the step of transmitting the first radio signal by the first terminal shown in FIG. 2.

FIG. 4: a schematic representation of radio communication between two electronic terminals according to the method of the invention, in an embodiment wherein the two electronic terminals each comprise two control units, and each are both transmitter and receiver.

FIG. 5: a detailed schematic representation of the step of reception of the first radio signal by a second terminal, shown in FIG. 2.

FIG. 6: a schematic representation of a pairing step between two electronic terminals.

FIG. 7: a schematic representation of the transmission and reception steps implemented by the first electronic terminal transmitting the first radio signal and having received a radio signal transmitted by another electronic terminal.

### DESCRIPTION OF THE INVENTION

According to a first aspect, the invention relates to a method for discovering a radio communication network and for filtering an audio signal S₁.

The method of the invention makes it possible to establish a group communication between several electronic terminals, noted T₁ . . . Tₓ, which are collocated in a same radio zone, noted G.

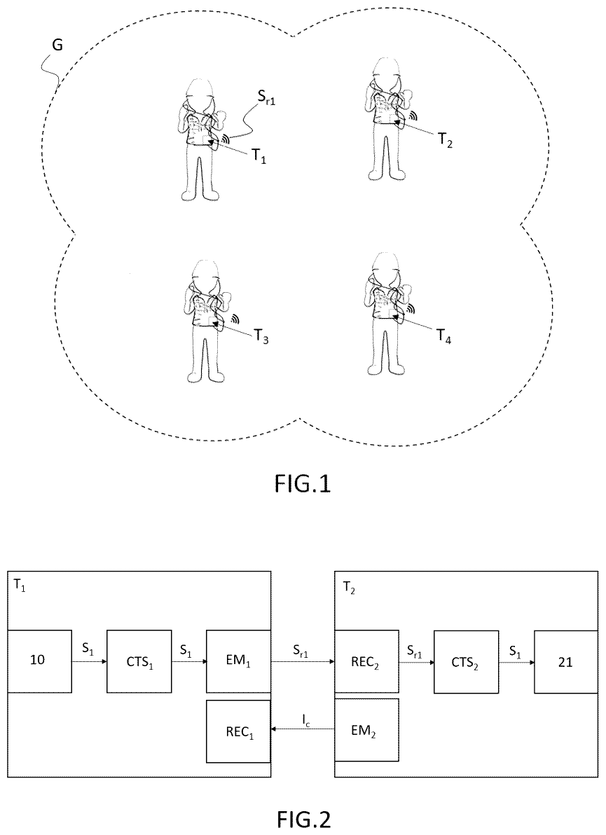

The notation T₁ . . . Tₓ illustrates that the number of electronic terminals communicating in the radio zone G is not limited in itself. FIG. 1 illustrates an embodiment in which four electronic terminals, noted T₁ . . . T₄, communicate with each other. However, the invention is not limited to the implementation of a predefined number of electronic terminals.

Radio zone G refers to a “communication bubble” in which the electronic terminals T₁ . . . Tₓ can be paired with each other, so as to establish a radio communication and so as to exchange data messages via radio signals, through a radio communication network. The radio zone G extends, for example, so that a maximum distance of 10 meters separates the electronic terminals T₁ . . . Tₓ that are furthest from each other. This communication range is interesting because it corresponds to the maximum range allowing natural communication between two individuals in a non-noisy environment. However, the invention is not limited to the communication range of the aforementioned example. This range may vary as a function of use cases, equipment and their configuration, number of users, and communication environments. According to another example, the communication range between the two furthest electronic terminals in the radio zone G is 40 meters.

“Radio communication network” means a set of radio channels allowing information to be exchanged by means of radio signals. This information is for example exchanged between the electronic terminals T₁ . . . Tₓ which are connected to each other via one or more of the radio channels.

The method comprises several steps making it possible to end up with a radio communication between the plurality of electronic terminals T₁ . . . Tₓ collocated in the radio zone G.

“Radio communication” means a data transfer by radio path between one or more transmitting terminals and one or more receiving terminals. For example, useful data is encoded in a radio signal and transmitted from the transmitting terminal to the receiving terminals via a radio communication interface making it possible to transmit and receive radio signals.

In the method of the invention, a same electronic terminal is for example both a transmitter and a receiver. In the present description, embodiments are described wherein the first terminal T₁ is a transmitting terminal and the terminals T₂ . . . Tₓ are receiving terminals. However, each terminal T₁ . . . Tₓ is capable of being both transmitter and receiver. Thus, the characteristics of a terminal T₁ . . . Tₓ may be applied directly to another terminal T₁ . . . Tₓ depending on whether it operates in a transmitter mode or in a receiver mode.

The present description illustrates the invention through various embodiments. Several embodiment alternatives are described for each of these embodiments. These alternatives may apply indifferently to each of these embodiments. Thus, the features described for one embodiment are directly applicable to another embodiment. The invention protects the different combinations of features described through all these embodiments.

### Transmission of a First Radio Signal

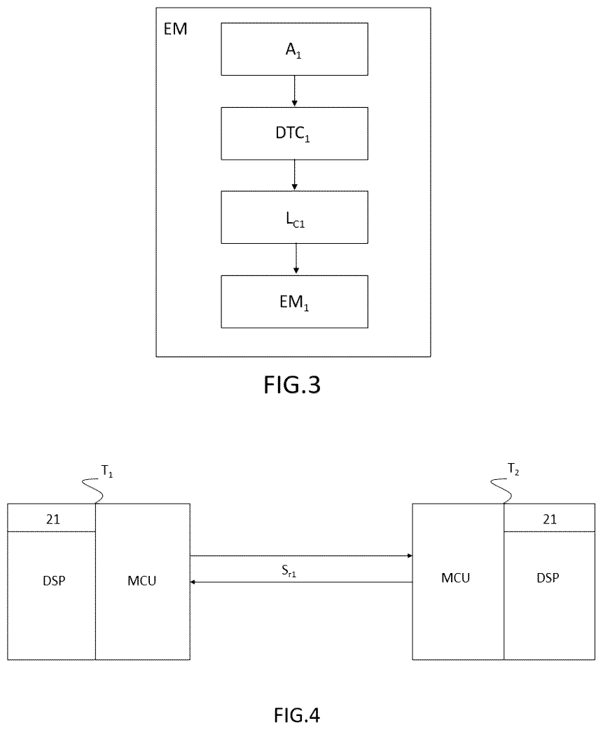

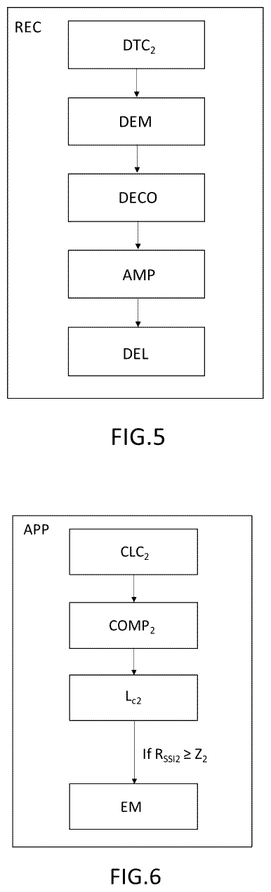

With reference to FIG. 2 and FIG. 3, the method comprises a first step of transmission, noted EM, of a first radio signal Sᵣ₁ by a first electronic terminal T₁. The transmission step EM comprises the acquisition A₁ of a first audio signal S₁ by a microphone 10 of the first terminal T₁. “Audio signal” means an electrical signal resulting from the reception and conversion of sound waves by the microphone 10. These are, for example, sound waves originating from a user of the first electronic terminal T₁ speaking, or sound waves originating from the environment in which the user moves. It may also be a combination of sound waves from these two sources, the user's voice and the surrounding environment}.

The transmission step EM comprises the detection DTC₁ of a characteristic data of a voice in the first audio signal S₁ acquired by the microphone 10. “Characteristic data of a voice” designates data whose detection makes it possible to identify that the first audio signal S₁ results from a user of the first electronic terminal T₁ speaking. In other words, this data makes it possible to distinguish an acquired audio signal resulting from the speaking of the user the closest to the microphone 10, from an acquired audio signal resulting from noise from the environment in which this user is located, such as for example the noise of a machine, or the noise of surrounding conversations.

The characteristic data of a voice is detected by means of a signal processing function. The signal processing function comprises, for example, a voice detection function. The signal processing function is for example implemented by means of a first DSP control unit integrated in the first terminal T₁. For example, it is a processor optimized to execute digital signal processing functions, such as a digital signal processor, also referred to in the literature as a “DSP”. It may be for example a microprocessor.

According to one embodiment, the first DSP control unit comprises two control units. For example, these are two digital signal processors. In this case, the first DSP control unit comprises, for example, two memory spaces for each of the two control units.

One advantage is to optimize the calculations by distributing them over each of the two control units. According to one example, one of the control units takes charge of the filtering of the first audio signal, and another control unit takes charge of the calculations allowing the detection of the characteristic data of a voice.

### Automatic Voice Detection

According to one embodiment, the step of detection of the characteristic voice data is automatically implemented in response to a detection of a sound signal by the microphone. This step is for example implemented automatically each time an audio signal is detected by the microphone, for example the first audio signal S₁.

One notable advantage is to dispense with prior art methods requiring prior action by the user before implementing the voice detection, such as using a means of actuation by the user, for example a “push to talk” button.

The first DSP control unit is for example configured to implement a signal processing chain allowing the detection of the characteristic voice data at each new acquisition of the microphone.

The implementation of the signal processing chain comprises for example the comparison of a parameter of the first audio signal S₁ with a threshold value, for example a comparison of an energy of the first audio signal S₁ with the threshold value.

The threshold value is for example calculated as a function of environmental parameters, such as surrounding noise parameters. These parameters comprise, for example, parameters relating to one or more signals acquired by means of a microphone. The threshold value is for example determined from the implementation of a mathematical function that depends on one or more of these parameters. For example, the threshold value is determined as a function of the amplitudes of the acquired signals. The threshold value is for example determined from the implementation of a mathematical operation, for example a sum of the squares of the amplitudes of the signals acquired over a given time interval.

According to one example, the threshold value is parameterized to be equal to the result of this mathematical operation.

According to another r example, the threshold value is parameterized to be greater than the result of this mathematical operation.

According to one embodiment, the step of filtering and the step of detection of a characteristic data of a voice are implemented on the first audio signal S₁ following a predefined sequence. The predefined sequence comprises, for example, the following steps:
reception of the first audio signal S₁ by the first DSP control unit of the first terminal;
implementation of a bandpass filter on the first audio signal S₁;
implementation of a voice detection function to detect the characteristic data of a voice in the first filtered audio signal S₁;
transmission of the first audio signal S₁ to a second MCU control unit when the characteristic data of a voice is detected in the first audio signal S₁.

### Adjustable Voice Detection Threshold

In one embodiment, the method comprises the acquisition of at least one second audio signal S₂ by the first terminal T₁.

The second audio signal S₂ is a signal used to parameterize a voice detection threshold S_{V}. The second audio signal S₂ comprises, for example, surrounding noise parameters.

In one embodiment, the method comprises the acquisition of the second signal S₂ by means of a microphone separate from the microphone configured to acquire the first audio signal S₁.

In one embodiment, the first audio signal S₁ is acquired by a first microphone and the second audio signal S₂ is acquired by a second microphone.

One advantage is to allow a more accurate calculation of the voice detection threshold.

In one embodiment, the method comprises a step of calculation of a first energy level E₁ of the first audio signal S₁.

In one embodiment, the method comprises a step of calculation of a second energy level E₂ of the second audio signal S₂.

In one embodiment, the method comprises a step of automatically parameterizing a voice detection threshold S_{V}. For example, the voice detection threshold Sᵥ is automatically parameterized as a function of the second calculated energy level E₂.

One advantage is to adjust the voice detection threshold to the ambient noise level. For example, the higher the surrounding noise, the higher the voice detection threshold will be adjusted.

In one embodiment, the method comprises a step of comparison of the first energy level E₁ with the voice detection threshold Sᵥ, the first control law L_{C1} being implemented when the first energy level E₁ is greater than the voice detection threshold Sᵥ.

One advantage is to condition the transmission of the first radio signal S₁ to a sufficient energy level of the audio signal captured by the microphone as a function of the ambient noise, and thus maximize the chances that the transmitted signal is a signal including a voice data.

In one embodiment, the characteristic data of a voice is detected when the first energy level E₁ is greater than the voice detection threshold Sᵥ.

One advantage is to condition the detection of the characteristic voice data in the first audio signal to a sufficient energy level of this signal relative to the ambient noise.

In one embodiment, the method comprises a step of acquiring a plurality of second audio signals S₂. For example, the second audio signals S₂ are acquired over a predetermined duration.

In one embodiment, the method comprises a step of calculating an average energy level of a plurality of second audio signals S₂, the voice detection threshold Sᵥ being automatically configured as a function of said average energy level.

In one embodiment, the average energy level of the second audio signals S₂ is recalculated automatically and periodically, the voice detection threshold Sᵥ being recalculated automatically each time said average energy level of the second audio signals S₂ is recalculated and as a function of said average energy level of the second signals S₂.

One advantage is to automatically and continuously parameterize a voice detection threshold that automatically adjusts as a function of the ambient noise level.

In one embodiment, the voice detection threshold Sᵥ is parameterized by means of the first audio signal S₁ or the second audio signal S₂.

In one embodiment, the voice detection threshold Sᵥ is parameterized by means of the first audio signal S₁ and the second audio signal S₂.

According to one embodiment, the method comprises the implementation of an equalizer. One advantage is to modify frequencies of the first audio signal S₁. The equalizer makes it possible, for example, to raise or lower certain frequencies to reinforce/lighten low or high frequencies, or to lower parasitic noises such as breathing noises. Another advantage of the equalizer is to make it possible to improve the signal quality when using an in-ear microphone. Indeed, the use of an in-ear microphone “smoothes” the signal on the high frequencies, and it is necessary to process this signal to increase its amplitude on the high frequencies upstream of its processing by the other elements of the signal processing chain. This advantageously makes it possible to improve intelligibility.

According to one embodiment, the method comprises the implementation of a noise reducer. One advantage of the noise reducer is that it helps to reduce surrounding noises to allow a better distinction of the voice signal in the first audio signal S₁.

According to one embodiment, the detection DTC₁ of a characteristic data of a voice comprises the detection of a characteristic spectrogram of a voice.

According to one embodiment, the detection DTC₁ of a characteristic data of a voice comprises the detection of a characteristic strength or spectral density of a voice.

According to one embodiment, the detection DTC₁ of a characteristic data of a voice comprises the detection of at least one characteristic spectral pattern of a voice.

According to one embodiment, the detection DTC₁ of a characteristic data of a voice comprises the calculation of a baseband signal-to-noise ratio. Such a calculation is for example implemented by means of the first control unit integrated in the first terminal T₁. The useful signal when it is not modulated is called the “baseband”. In other words, a distinction is made between the useful signal (e.g. the first audio signal S₁) and the useful signal transported via a modulated carrier wave.

When the characteristic data of a voice has been detected in the first audio signal S₁, the step of transmission EM comprises the implementation of a first control law L_{C1}. This first control law L_{C1} comprises the filtering, the compression and the modulation of the first audio signal S₁.

One advantage of implementing the first control law L_{C1} only following voice detection is to reduce the energy consumption of the system. For example, in a broadcast communication mode, the first terminal T₁ will only transmit radio signals when the user of the first terminal T₁ speaks.

Another advantage is to reduce the saturation level of the radio channel by avoiding the transmission of parasite signals, for example when a microphone of the first terminal only picks up the surrounding noise.

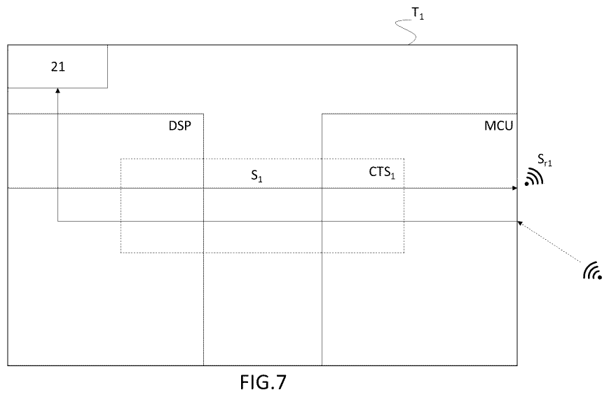

These steps are implemented by a signal processing chain CTS₁. With reference to FIG. 4 and FIG. 7, the signal processing chain CTS₁ is for example executed by two separate control units. They are, for example, the first DSP control unit and a second MCU control unit. The first DSP control unit and the second MCU control unit are for example integrated in the first terminal T₁. The filtering step is, for example, implemented by the first DSP control unit. For example, the compression and modulation steps are implemented by the second MCU control unit. The second MCU control unit comprises for example an integrated circuit comprising a processor, a memory and input-output peripherals. It may be for example a microcontroller.

In one embodiment, the first DSP control unit comprises the second MCU control unit.

According to one embodiment, the implementation of the first control law L_{C1} comprises the implementation of the equalizer. For example, the equalizer is implemented between the step of filtering and the step of compression of the first audio signal S₁ in the signal processing chain.

According to one embodiment, the implementation of the first control law L_{C1} comprises the implementation of the noise reducer. The noise reducer is for example implemented between the step of filtering and the step of compression of the first audio signal S₁ in the signal processing chain.

For example, the first DSP control unit and the second MCU control unit are connected via a wired connection that allows information to be exchanged between the two DSP, MCU control units. For example, they communicate with each other via an “Integrated Interchip Sound” connection, also known as “I2S”.

The filtering comprises, for example, the implementation of a bandpass filter on the first audio signal S₁.

According to one embodiment, the filtering comprises the implementation of a bandpass filter whose bandwidth is between 300 Hz and 3.5 kHz. According to another example, the filtering comprises the implementation of a bandpass filter whose bandwidth is between 200 Hz and 4 kHz.

According to one embodiment, the method comprises the implementation of a bandpass filter whose bandwidth is between 300 Hz and 3.5 kHz and a function for detecting a characteristic data of a voice. The function of detecting a characteristic data of a voice is for example implemented after the filtering step in the signal processing chain. According to one case, the method also comprises the implementation of an equalizer. For example, the equalizer is positioned at the last position in the signal processing chain.

One advantage is to enable the use of an in-ear microphone by improving the signal quality to increase intelligibility.

According to one embodiment, the method comprises the implementation of a low-pass filter. For example, the low-pass filter has a cut-off frequency between 300 Hz and 400 Hz. According to one case, the step of detecting a characteristic data of a voice and the step of filtering are implemented in parallel in the method. For example, the first audio signal S₁is split into two signals. One of the signals is for example processed to detect the presence or not of a characteristic data of a voice in a signal. If the characteristic data of a voice is detected, then for example a multiplication by “1” is implemented between the two signals, so that the first filtered audio signal S₁ is either delivered at the output of the first DSP control unit to the second MCU control unit, for example following an I2S protocol, or processed by another function of the signal processing chain, for example a limiter, before it is sent to the second MCU control unit. If the characteristic data of a voice is not detected in the second signal, then a multiplication by “0” is implemented, for example, between the two signals. Advantageously, this makes it possible to transmit only the signals in which the characteristic data of a voice has been detected by the signal processing chain.

According to one case, the method also comprises the implementation of a limiter. The limiter is for example implemented after the function of detecting a characteristic data of a voice in the signal processing chain. According to one case, the method also comprises the implementation of a reducer. The reducer is for example configured to act as a bandpass filter whose bandwidth is between 250 Hz and 2500 Hz. One advantage of this embodiment is to allow the use of a microphone positioned in front of the mouth of the user while optimizing the signal quality to allow better intelligibility.

One advantage is to filter specific frequencies of the first audio signal S₁ in a targeted manner so as to retain the frequencies of the voice and to attenuate the other frequencies, to improve the quality of the communication.

According to one embodiment, the filtering step comprises the step of detection DTC₁ of the characteristic data of a voice.

The compression of the first audio signal S₁ is for example carried out by means of an audio compression algorithm. This algorithm is implemented, for example, by the second MCU control unit. The audio compression algorithm comprises for example the implementation of an audio codec. The audio codec comprises, for example, an open audio compression format. This is, for example, an audio compression format with losses. For example, it is an OPUS codec. For example, the audio codec is parameterized with specific parameters to correspond to requirements of the second MCU control unit, for example requirements in terms of processing time and/or random-access memory, also referred to by the acronym “RAM” in the literature. The specific parameters comprise, for example, the implementation of a low-latency time algorithm, such as an algorithm designated in the literature by the name “Constrained Energy Lapped Transform”, or by the acronym CELT.

The first filtered and compressed audio signal S₁ is then modulated to obtain a first radio signal Sᵣ₁ capable of being transmitted within a radio channel. The first radio signal Sᵣ₁ is transmitted by means of a radio transmitter EM₁ of the first electronic terminal T₁, and via a wireless connection. It is, for example, a Bluetooth connection or a Wi-Fi connection.

According to one embodiment, the first radio signal Sᵣ₁ is transmitted in accordance with a mesh network protocol. For example, this is a protocol for wireless networks in the LR WPAN family (Low-Rate Wireless Personal Area Network). For example, it is a network protocol based on IPv6 (Internet Protocol version 6). For example, it is an 802.15.4 mesh network protocol, such as “Thread”.

According to one embodiment, the method comprises the implementation of a routing table. In this case, the method comprises for example the designation of a “leader” electronic terminal. The “leader” electronic terminal manages, for example, the routing table. One advantage is to allow the transition from a protocol not implementing a routing table to a protocol implementing a routing table, such as a mesh network protocol 802.15.4, for example “Thread”. According to this embodiment, when the “leader” electronic terminal leaves the communication zone, for example the radio zone G, a new “leader” terminal is automatically redesignated. One advantage is to allow the leaving of the “leader” terminal from the radio zone not to affect the continuity in the communications. This implementation is particularly advantageous compared to prior art methods implementing a centralizing apparatus, the presence of which is required to enable the operation of communications between the electronic terminals.

In one embodiment, the step of transmitting the first radio signal Sᵣ₁ comprises a step of comparing a number of transmitters having transmitted within a radio reception channel with a threshold value to authorize or not the transmission of the first radio signal Sᵣ₁. For example, the comparison step is performed in real time.

According to one embodiment, when the number of transmitters is greater than the threshold value at a given time, the first radio signal Sᵣ₁ is not transmitted.

In one embodiment, the method comprises the implementation of a predetermined time delay preceding an authorization to transmit the first radio signal Sᵣ₁. For example, an electronic terminal T₁ . . . Tₓ can authorize the transmission of the first radio signal Sᵣ₁ when the number of transmitters is below the threshold value for a given period, for example a pre-parameterized period.

One advantage is to avoid having too many users speak together to maintain sufficient intelligibility of the conversation. For example, a user is muted when the radio reception channel is overloaded.

In one embodiment, the step of transmitting the first radio signal Sᵣ₁ comprises the transmission of an identifier of the transmitting terminal. For example, it is a unique physical identifier stored in a network card of the first terminal T₁.

In one embodiment, the reception of the first radio signal Sᵣ₁ comprises a step of identifying the transmitter of said first radio signal Sᵣ₁. The identification step comprises, for example, a step of analyzing parameters of the first radio signal Sᵣ₁ by means of a control unit. This is for example an analysis of a given sequence of parameters in the signal. For example, a radio frame of the first radio signal Sᵣ₁ is analyzed and compared with predefined parameters to authorize or not the communication between the transmitting terminal and the receiving terminal. Analysis of the sequence of parameters of the first radio signal Sᵣ₁ makes it possible, for example, to determine the nature of a radio communication protocol of the transmitting terminal.

One advantage is to check a compatibility of the communication protocol of the transmitting terminal with that of the receiving terminal.

Another advantage is to limit the reception of parasitic signals, for example signals from a transmitter other than a terminal of the plurality of electronic terminals T₁ . . . Tₓ.

### Calculation of the First Received Strength Value R_{SSI}

The method comprises a step of calculating a received signal strength value R_{SSi}. This is, for example, the strength of the first radio signal Sᵣ₁ transmitted via the wireless connection.

According to another example, it is the strength of a pairing signal sent by the first electronic terminal T₁.

The acronym R_{SSI} used in the present description does not limit the received signal strength to a strength corresponding to an indicator of the power of the received signal designated by the acronym RSSI. According to one embodiment, the received signal strength value R_{SSi} comprises a communication quality indicator also designated in the literature by the term “link quality indicator”, or even by the acronym LQI.

According to one embodiment, the calculated received signal strength R_{SSI} comprises an average of the received strengths over a given period. It is for example an average of received strengths of several signals transmitted by a given transmitter, for example an average of strengths of a plurality of first radio signals Sᵣ₁ transmitted by the first electronic terminal T₁. For example, it is an exponential moving average. In this case, the average of the received strengths is for example calculated taking into account an order of reception of the signals. The exponential moving average is for example calculated over a given period using a weighting of the received strengths that decreases exponentially as a function of the order of reception of the signals. In this case, a higher coefficient is for example assigned to the last received signals for the calculation of the average, and this coefficient decreases, for example exponentially for the signals received previously.

This calculation is implemented, for example, by means of a control unit integrated into the electronic terminals T₁ . . . Tₓ. This is, for example, the second MCU control unit.

The method then comprises a step of comparison COMP₁ of the calculated strength value with a first threshold. The comparison step COMP₁ is for example performed by means of a comparison function. This function is implemented, for example, by the control unit which has made it possible to calculate said strength value.

According to one embodiment, the pairing step APP is not implemented when the calculated received signal strength value R_{SSI} is less than the threshold value. In this case, if a pairing signal received by an electronic terminal T₁ . . . Tₓ is too weak, then the electronic terminals do not pair.

According to one embodiment, the steps of calculation of the received signal strength value R_{SSI}, and comparison COMP₁ of the calculated strength value with a threshold value are implemented by an electronic terminal T₁ . . . Tₓ on reception of a radio signal transmitted by an electronic terminal with which it has previously paired.

According to another example, in a broadcast communication mode not requiring prior pairing, the calculation of the received signal strength value R_{SSI} is performed each time a radio signal is received again by an electronic terminal of the plurality of electronic terminals T₁ . . . Tₓ.

One advantage is to detect whether a signal is sufficiently energized upstream of its transmission to an audio output of a receiving terminal.

According to one embodiment, the method comprises the calculation of a value of a communication quality indicator, also referred to in the literature by the term “link quality indicator”, or even by the acronym LQI. Such an indicator makes it possible to quantify the quality of communication between the transmitting and receiving terminals.

According to one embodiment, any one of the steps implemented by the method comprising the comparison of a strength value R_{SSI} with a threshold value and the conditioning of a step of the method to the result of this comparison is performed by comparing the value of the communication quality indicator LQI with a threshold value.

According to one embodiment, a received signal strength value R_{SSI} is calculated and compared with one or more threshold values each time a signal is received by an electronic terminal T₁ . . . Tₓ.

According to one embodiment, the radio signals received by one or more electronic terminals T₁ . . . Tₓ are not processed when the received signal strength value R_{SSI} is less than a threshold value. “The radio signals are not processed” means that the demodulation and decompression steps are not implemented on said radio signals.

### Reception of the Radio Signal by the Receiving Terminals

With reference to FIG. 5, the method comprises a step of reception REC of the first radio signal Sᵣ₁ by a plurality of electronic terminals T₂ . . . Tₓ. The electronic terminals T₂ . . . Tₓ are collocated in a same radio zone G as the first terminal T₁. This radio zone G delimits the maximum range at which the first radio signal Sᵣ₁ transmitted by the first terminal T₁ can be received by a receiving terminal. More generally, this radio zone G delimits a “communication bubble”, in which the terminals T₁ . . . Tₓ can pair to establish a group communication.

Each electronic terminal of the plurality of electronic terminals T₂ . . . Tₓ comprises for example a radio communication interface REC₂ . . . RECₓ to receive the first radio signal Sᵣ₁. This is, for example, a radio antenna.

The step of reception REC comprises the detection DTC₂ of the first radio signal Sᵣ₁ by a radio communication interface of each electronic terminal of the plurality of electronic terminals T₂ . . . Tₓ.

The step of reception REC comprises the baseband demodulation DEM of the first radio signal Sᵣ₁. The baseband derived from the demodulation DEM comprises the first filtered audio signal S₁. This demodulation step is implemented, for example, by means of a second MCU control unit of the electronic terminals T₂ . . . Tₓ.

The step of reception REC comprises the decompression DECO of the first filtered audio signal. This step is performed by a second signal processing chain CTS₂ of each of the electronic terminals T₂ . . . Tₓ. The second signal processing chain CTS₂ is for example implemented by means of the second MCU control unit of the second electronic terminals T₂ . . . Tₓ.

The step of reception REC comprises the amplification AMP of the first decompressed audio signal S₁. The amplification AMP is performed by the second signal processing chain CTS₂. This amplification step is for example implemented by means of a first DSP control unit of the electronic terminals T₂ . . . Tₓ. In this case, the first DSP control unit and the second MCU control unit of the electronic terminals T₂ . . . Tₓ are for example connected to each other via a wired connection allowing data exchange, for example the transmission of the first filtered and decompressed audio signal S₁ from the second MCU control unit to the first DSP control unit. For example, the first DSP control unit and the second MCU control unit are connected via an I2S link.

The step of reception REC comprises the delivery of the first amplified audio signal S₁ to an audio output 21 of each terminal among the plurality of terminals T₂ . . . Tₓ. The audio output 21 is for example connected to the first DSP control unit via a wired connection. The audio output 21 comprises, for example, one or two earpieces allowing the first audio signal S₁ to be played back to the ears of a user.

The steps of demodulation DEM and decompression DECO of the first radio signal Sᵣ₁ are not implemented when the calculated received signal strength value R_{SSI} is less than the threshold value.

One advantage is to limit the power consumption of the system. Indeed, if the strength value of the first audio signal S₁ is lower than the predetermined threshold, this means, for example, that the transmitted radio signals will be too weak for the encoded audio signals to be audible by a user of a receiving terminal. Thus, if the signal processing chain is not activated in this case, this allows the system to save energy over time.

According to one embodiment, the reception step REC comprises the automatic transmission EM₂ of a communication establishment indicator (IC₂ . . . ICₓ) of each terminal, among the plurality of terminals T₂ . . . Tₓ, to the first terminal T₁. This indicator is intended to indicate that communication is established between each receiving terminal and the first terminal T₁. For example, it is an indicator encoded in a data frame, transmitted by the receiving electronic terminals T₂ . . . Tₓ to the first electronic terminal T₁. For example, the first electronic terminal T₁ decodes this data frame to identify that the connection is properly established.

In one embodiment, the step of transmitting the first radio signal Sᵣ₁ comprises a step of normalizing sound intensity parameters of the first audio signal S₁. The sound intensity parameters of the first audio signal S₁ are for example normalized as a function of a predefined value, for example to reach a predetermined sound intensity target value.

One advantage is to ensure delivery of a constant sound level to a user of the receiving terminal, independent of the ambient noise level at each transmitter and independent of the voice energy level of each user.

### PLC Algorithm

In one embodiment, the reception of the first radio signal Sᵣ₁ by an electronic terminal comprises the implementation of an algorithm to generate a non-received or degraded portion of said first radio signal from a received portion of said first radio signal. This algorithm is for example implemented when the electronic terminals communicate with each other in a broadcast communication mode. The first radio signal Sᵣ₁ is for example transmitted in packet form, and a signal portion corresponds for example to a number of packets, for example 1. The algorithm used is, for example, a PLC algorithm, an acronym for “packet loss concealment” in the literature. For example, lost packets are regenerated from received packets.

One advantage is to avoid degradation of the audio signal transmitted to a user of a receiving terminal.

### Hysteresis

In one embodiment, the method comprises a step of automatically disconnecting at least one electronic terminal T₁ . . . Tₓ as a function of a result of comparing the received signal strength value Rₛₛᵢ with a threshold value. For example, it is a second threshold different from the first threshold.

According to one example, when the result of an exponential moving average of the strengths of a plurality of signals transmitted by a same electronic terminal and received by another electronic terminal over a given period is less than a threshold value, then the electronic terminals are disconnected. For example, the electronic terminals T₁ . . . Tₓ are disconnected so that the signals transmitted by one of the terminals are no longer processed by the other terminal.

One advantage is to avoid the reception of degraded radio signals, and to maintain an acceptable level of intelligibility in conversations between users.

### Implementation of the Steps of the Method by Each Terminal

According to one embodiment, the first terminal T₁ is configured to implement the reception step REC of the method.

According to one embodiment, at least one terminal among the plurality of terminals T₂ . . . Tₓ is configured to implement the transmission step EM of the method.

According to one embodiment, at least one terminal among the plurality of terminals T₂ . . . Tₓ is configured to implement the step of calculating a received signal strength R_{SSI} and the step of comparison COMP of the calculated strength with a threshold value.

According to one embodiment, the first terminal T₁ is configured to implement the step of calculating a received signal strength R_{SSI} and the step of comparison COMP of the calculated strength with a threshold value.

### Pairing of Terminals or Version Without Pairing

According to one embodiment, the electronic terminals T₁ . . . Tₓ communicate with each other without the implementation of a prior pairing step. The electronic terminals T₁ . . . Tₓ communicate, for example, according to an IEE 802.15.4 communication protocol.

According to one embodiment, the method comprises a step of pairing APP between the first terminal T₁ and the plurality of terminals T₂ . . . Tₓ. This step is prior to the transmission step EM of the method. This pairing step makes it possible to establish a radio connection allowing data exchange between the first terminal T₁ and the plurality of terminals T₂ . . . Tₓ.

The pairing step APP comprises the calculation CLC₂ of a second received strength value RSSI₂ of a pairing signal Sₐₚ by each terminal among the plurality of terminals T₂ . . . Tₓ. The pairing signal Sₐₚ is, for example, a radio signal sent by an electronic terminal T₁ . . . Tₓ, to determine the presence of other electronic terminals in the radio range G, and to establish radio communication with the detected electronic terminals if applicable. The pairing step is implemented, for example, by means of one of the DSP, MCU control units of each T₂ . . . Tₓ terminal.

The pairing step APP comprises the comparison COMP₂ of the second received strength value RSSI₂ calculated with a second threshold Z₂. The second threshold Z₂ is for example different from the first threshold. According to another example, the first threshold and the second threshold Z₂ are equal values.

The pairing step APP comprises the implementation of a second control law L_{C2}. The second control law LC₂ makes it possible to check whether the second calculated received strength value R_{SSI2} is greater than the second threshold Z₂. If this criterion is met, the second control law L_{C2} allows, for example, the implementation of the step of transmission EM of the first radio signal Sᵣ₁ by the first terminal T₁. According to one case, if this criterion is not met, the second control law LC₂ blocks the implementation of the step of transmission EM of the first radio signal Sᵣ₁ by the first terminal T₁.

One advantage is to reduce the energy consumption of the system, by preventing the implementation of the transmission step EM of the method when the communication between the terminals is not optimal, for example when the transmitting terminal and the receiving terminals are too far away, or when the radio signals are disturbed in the radio transmission channel, preventing good radio reception by the receiving terminals.

According to one embodiment, the pairing step APP is implemented at the first terminal T₁. In this case, the first terminal T₁ transmits for example the pairing signal Sₐₚ to the other terminals T₂ . . . Tₓ, which in turn transmits a signal, in response to the reception of the pairing signal Sₐₚ.

According to one embodiment, the pairing step is implemented at one of the receiving electronic terminals T₂ . . . Tₓ. In this case, one of the electronic terminals T₂ . . . Tₓ transmits the pairing signal Sₐₚ, which is received by the first electronic terminal T₁ and/or by an electronic terminal of the plurality of electronic terminals T₂ . . . Tₓ, which transmit in turn a signal, in response to the reception of the pairing signal Sₐₚ.

According to one embodiment, the first terminal T₁ and the plurality of electronic terminals T₂ . . . Tₓ communicate with each other without the prior implementation of the pairing step APP.

According to one embodiment, the step of pairing APP of the first terminal T₁ with the plurality of terminals T₂ . . . Tₓ comprises a step of addressing APP said plurality of terminals T₂ . . . Tₓ by the first terminal T₁. The addressing step comprises, for example, the assignment of an IP address to at least one terminal among the plurality of terminals T₂ . . . Tₓ.

### Broadcast Communication Between Electronic Terminals

According to one embodiment, the communication interfaces of each electronic terminal T₁ . . . Tₓ ensure broadcast wireless communications.

“Communication interfaces” means the transmitters and receivers of radio signals of each of the electronic terminals T₁ . . . Tₓ.

“Broadcast” wireless communications means the transmission of radio signals by the electronic terminals T₁ . . . Tₓ without these radio signals being intended to be received by a specific electronic terminal. In other words, radio signals are transmitted by a transmitting electronic terminal, for example the first electronic terminal T₁, and are received and decoded by all the electronic terminals sufficiently close to the transmitting electronic terminal. These are, for example, electronic terminals in the radio range G. The radio signals are, for example, only received and decoded by electronic terminals that are paired with the transmitting terminal.

The broadcast wireless communication allows for example the transmission and reception of datagrams in accordance with a user datagram protocol. Such a protocol is also known in the literature as the “User Datagram Protocol”. In the telecommunications field, such a protocol is also referred to as the “UDP protocol”.

“Datagrams” means a set of data transmitted with its source addresses and its destination addresses by a telecommunications network.

### Communication System Comprising Electronic Terminals

According to another aspect, the invention relates to a system comprising the first electronic terminal T₁ and the plurality of electronic terminals T₂ . . . Tₓ, configured to implement the method for discovering a radio communication network and for filtering an audio signal.

The first terminal T₁ comprises for example the first DSP control unit and the second MCU control unit. These two DSP, MCU control units are for example configured to implement the step of transmission EM of the first radio signal Sᵣ₁ of the method.

Each of the terminals of the plurality of electronic terminals T₂ . . . Tₓ comprises for example a first DSP control unit and a second MCU control unit. These two DSP, MCU control units are for example configured to implement the steps of reception REC of the first radio signal Sᵣ₁.

According to one embodiment, at least one electronic terminal among the plurality of electronic terminals T₂ . . . Tₓ is configured to implement the step of transmission EM of the first radio signal Sᵣ₁.

According to one embodiment, the first electronic terminal T₁ is configured to implement the step of reception REC of the first radio signal Sᵣ₁.

Thus, in the system of the invention, each of the electronic terminals is for example both a transmitting terminal and a receiving terminal. This advantageously allows group communication via an exchange of radio signals Sᵣ₁ between the electronic terminals T₁ . . . Tₓ.

### Communication System Between Only Two Electronic Terminals

According to another aspect, the invention relates to a system comprising the first electronic terminal T₁ and a second electronic terminal T₂, configured to implement the steps of the method for discovering a radio environment and for filtering an audio signal. In this case, the first electronic terminal T₁ is for example configured to implement the transmission step EM of the method and the second electronic terminal T₂ is for example configured to implement the reception step REC of the method. Each of the two electronic terminals T₁, T₂ comprises for example a first DSP control unit and a second MCU control unit. For example, the two electronic terminals T₁, T₂ are both configured to implement the steps of transmission EM and reception REC of the first radio signal Sr. This enables bidirectional information exchange between the two electronic terminals T₁, T₂ via a wireless radio link.

### Computer Program Product

According to another aspect, the invention relates to a computer program product comprising instructions which, when the program is executed by a computer, lead the latter to implement the following steps
Detection of a characteristic data of a voice in a first received audio signal S₁;
Implementation of a first control law L_{c1}, when the characteristic data of a voice is detected in the first audio signal S₁, comprising:
   Filtering of the first audio signal S₁;
   Compression of the first audio signal S₁ using an audio codec;
   Modulation of the first audio signal S₁ to obtain a first radio signal Sᵣ₁ capable of being transmitted within a radio channel by a radio transmitter;

According to one embodiment, the computer capable of executing the computer program product comprises the first DSP control unit and the second MCU control unit.

According to one embodiment, the electronic terminals T₁ . . . Tₓ comprise a housing. The housing comprises, for example, the first DSP control unit and the second MCU control unit and means for transmitting and receiving radio signals. The housing is for example connected in a wired or non-wired manner to earpieces of a user to enable the delivery of an audio signal.

According to one embodiment, at least one electronic terminal T₁ . . . Tₓ comprises a microphone integrated in the housing.

According to one embodiment, the computer program product comprises instructions which, when the program is executed by a computer, lead it to implement a calculation of a received strength, to compare the received strength value with a threshold value and to authorize the implementation of the transmission EM or reception REC step of the method only when said received strength value is greater than or equal to the threshold value.

In summary, the invention relates to a method for discovering a radio communication network and for filtering an audio signal, an associated system, and an associated computer program product. The invention advantageously allows intelligible e communication between several interlocutors collocated in a same radio zone. The invention advantageously makes it possible to maintain a good level of intelligibility of conversations independently of the surrounding noise level.

1. A method for discovering a radio communication network and for filtering an audio signal, said method allowing a group communication between a plurality of electronic terminals collocated in a radio zone, each electronic terminal comprising at least one communication interface for transmitting and receiving radio signals, the method comprising:
transmitting a first radio signal by a first electronic terminal including:
acquiring the first audio signal by a microphone;
detecting a characteristic data of a voice in the first audio signal by implementing a first signal processing function;
implementing a first control law to implement the following steps when the characteristic data of a voice has been detected in the first audio signal;
i. filtering, encoding comprising a step of compression and modulation, by a signal processing chain, of said first acquired audio signal, to obtain the first radio signal capable of being transmitted within a radio channel;
ii. of transmitting the first radio signal by means of a radio transmitter and via a wireless connection;
receiving said first radio signal by a plurality of electronic terminals, comprising:
detecting the first radio signal by a radio communication interface of each terminal among the plurality of electronic terminals;
calculating a received signal strength value and comparison of comparing said calculated received signal strength value with a first threshold;
implementing the following steps when said received signal strength value is greater than said first threshold:
i. baseband demodulating comprising the first filtered audio signal of said first radio signal;
ii. decompressing and amplifying, by a second signal processing chain, of said first filtered audio signal,
iii. delivering the first decompressed and amplified audio signal to an audio output of each terminal among the plurality of electronic terminals.

2. The method according to claim 1, wherein the received signal strength value comprises a communication quality indicator, and wherein the calculation of said received signal strength value comprises the calculation of an exponential moving average of strength values of a plurality of first radio signals transmitted by the first terminal.

3. The method according to claim 1, wherein the signal processing function for detecting the characteristic data of a voice is implemented automatically in response to the acquisition of the first audio signal by the microphone.

4. The method according to claim 1, comprising:
acquiring a second surrounding noise audio signal by means of a microphone;
calculating a first energy level of the first audio signal and a second energy level of the second audio signal by means of the first control unit;
automatic parameterizing a voice detection threshold as a function of the energy level of the calculated second audio signal;
comparing the first energy level with said voice detection threshold,
the first control law being implemented when the first energy level is greater than the voice detection threshold.

5. The method according to claim 4, comprising:
acquiring a plurality of second audio signals by means of a microphone for a first duration;
calculating an average energy level of the second audio signals by means of the first control unit;
automatic parameterizing the voice detection threshold as a function of the average energy level calculated by means of the first control unit.

6. The method according to claim 5, wherein the average energy level of the second audio signals is automatically and periodically recalculated, the voice detection threshold being automatically recalculated each time said average energy level of the second signals is recalculated.

7. The method according to claim 1, wherein the detection of the characteristic data of a voice in the first audio signal comprises the comparison of the first energy level with the voice detection threshold, the characteristic data of a voice being detected when the first energy level is greater than the voice detection threshold.

8. The method according to claim 1, wherein the transmitting of the first radio signal comprises normalizing sound intensity parameters of the first audio signal as a function of a parameterizable threshold.

9. The method according to claim 1, wherein the receiving of the first radio signal comprises a step of identifying the first electronic terminal by the receiving terminal, said identifying comprising a comparison of a sequence of parameters of the first radio signal with predefined parameters to allow or not the reception of the first radio signal.

10. The method according to claim 1, wherein the transmitting of the first radio signal comprises a real-time comparison of a number of transmitters within a radio channel with a threshold value, the first control law being implemented only when said number of transmitters is less than said threshold value.

11. The method according to claim 1, wherein the reception of the first radio signal comprises the implementation of an algorithm to generate a non-received or degraded portion of said first radio signal from a received portion of said first radio signal.

12. The method for discovering and for filtering according to claim 1, wherein the communication interface of each electronic terminal allows wireless communications broadcast to the other terminals, and allows the transmission and reception, by each electronic terminal, of datagrams in accordance with a user datagram protocol.

13. A communication system comprising a plurality of electronic terminals capable of communicating with each other when said plurality of electronic terminals is collocated in a same radio zone, each electronic terminal comprising:
a microphone to acquire a first audio signal;
a radio transmitter to:
transmit a first radio signal within a radio channel;
a radio receiver to receive a radio signal comprising a data frame encoding an audio signal;
a first control unit to execute a first signal processing chain configured to implement:
a step of processing the first audio signal acquired by the microphone comprising:
i. detection of a characteristic data of a voice in the first local audio signal by means of a signal processing function;
ii. implementation of a first control law when the characteristic data of a voice has been detected in the first local audio signal, comprising the filtering of the first audio signal to obtain a first filtered audio signal;
a second control unit to implement:
before the transmission of the first radio signal:
i. reception of the first filtered audio signal;
ii. encoding comprising the compression and modulation of the first filtered audio signal to obtain the first radio signal capable of being transmitted within a radio channel;
on reception of a radio signal:
i. calculation of a received radio signal strength value and comparison of said calculated received radio signal strength value with a first threshold and, when said received radio signal strength value is greater than the first threshold:
a. baseband demodulation of the received radio signal to obtain an audio signal;
b. decompression of said audio signal,
c. delivery of the decompressed audio signal to the first control unit which amplifies said decompressed audio signal and delivers said decompressed and amplified audio signal to an audio output of the terminal.

14. The communication system according to claim 13, wherein the second control unit is configured to implement a control law comprising:
generation of a radio signal reception authorization control when the calculated received signal strength value is greater than or equal to the first threshold,
generation of a radio signal reception blocking control when the calculated received signal strength value is less than the first threshold.
